(19) United States
(12) Patent Application Publication
(10) Pub. No.: US 2004/0264088 A1
(43) Pub. Date: Dec. 30, 2004

(54) Undervoltage relay controller

(75) Inventors: William P. Hooper, Duluth, GA (US); Scott C. Turner, Lilburn, GA (US)

Correspondence Address: James A. Wilke, FOLEY & LARDNER, Suite 3800, 777 East Wisconsin Avenue, Milwaukee, WI, 53202-5306, US

(73) Assignee: Siemens Energy & Automation, Inc.

(21) Appl. No.: 10/685,157

(22) Filed: Oct. 14, 2003

Related U.S. Application Data
(60) Provisional application No. 60/483,150, filed on Jun. 27, 2003.

(51) Int. Cl. H02H 3/24

(52) U.S. Cl. 361/92

(57) ABSTRACT

A method and apparatus for an undervoltage relay control apparatus monitoring voltage of the circuit breaker. The undervoltage relay controller apparatus comprises a housing with a latch assembly mounted in the housing. The latch assembly includes a latch mechanism and a solenoid, with the solenoid in selective contact with the latch mechanism. An electrical circuit, having a voltage input and a voltage output is mounted in the housing and coupled to the latch assembly. Wherein a control voltage input to the electrical circuit is conditioned, independently of parameters of the solenoid, and wherein if the received control voltage input is less than a predefined voltage, the electrical circuit will remove power to the solenoid allowing the solenoid to contact the latch mechanism and trip the circuit breaker.

### CROSS-REFERENCE TO RELATED PATENT APPLICATIONS

This application claims the benefit of U.S. Provisional Application No. 60/483,150, filed Jun. 27, 2003.

### BACKGROUND OF THE INVENTION

The present invention relates generally to the field of circuit breakers and more particularly to a molded case circuit breaker with a precision undervoltage relay controller device.

In general the function of a circuit breaker is to electrically engage and disengage a selected circuit from an electrical power supply. This function occurs by engaging and disengaging a pair of operating contacts for each phase of the circuit breaker. The circuit breaker provides protection against persistent overcurrent conditions and against the very high currents produced by short circuits. Typically, one of each pair of the operating contacts are supported by a pivoting contact arm while the other operating contact is substantially stationary. The contact arm is pivoted by an operating mechanism such that the movable contact supported by the contact arm can be engaged and disengaged from the stationary contact.

There are two modes by which the operating mechanism for the circuit breaker can disengage the operating contacts: the circuit breaker operating handle can be used to activate the operating mechanism; or a tripping mechanism, responsive to unacceptable levels of current carried by the circuit breaker, can be used to activate the operating mechanism. For many circuit breakers, the operating handle is coupled to the operating mechanism such that when the tripping mechanism activates the operating mechanism to separate the contacts, the operating handle moves to a fault or tripped position.

To engage the operating contacts of the circuit breaker, the circuit breaker operating handle is used to activate the operating mechanism such that the movable contact(s) engage the stationary contact(s). A motor coupled to the circuit breaker operating handle can also be used to engage or disengage the operating contacts. The motor can be remotely operated.

A typical industrial circuit breaker will have a continuous current rating ranging from as low as 15 amps to over 1200 amps. The tripping mechanism for the breaker usually consists of a thermal overload release and a magnetic short circuit release. The thermal overload release operates by means of a bimetallic element, in which current flowing through the conducting path of a circuit breaker generates heat in the bi-metal element, which causes the bi-metal to deflect and trip the breaker. The heat generated in the bi-metal is a function of the amount of current flowing through the bi-metal as well as for the period of time that that current is flowing. For a given range of current ratings, the bi-metal cross-section and related elements are specifically selected for such current range resulting in a number of different circuit breakers for each current range.

An industrial circuit breaker may also be provided with an electronic trip unit. The electronic trip unit senses overcurrent with amplification circuits which provide corresponding analog inputs to a microprocessor controllers like the bimetallic element trip unit, the electronic unit will cause a time-delay trip as a function of overcurrent magnitude.

In the event of current levels above the normal operating level of the thermal overload release, it is desirable to trip the breaker without any intentional delay, as in the case of a short circuit in the protected circuit, therefore, an electromagnetic trip element is generally used. In a short circuit condition, the higher amount of current flowing through the circuit breaker activates a magnetic release which trips the breaker in a much faster time than occurs with the bi-metal heating. It is desirable to tune the magnetic trip elements so that the magnetic trip unit trips at lower short circuit currents at a lower continuous current rating and trips at a higher short circuit current at a higher continuous current rating. This matches the current tripping performance of the breaker with the typical equipment present downstream of the breaker on the load side of the circuit breaker.

In certain situations, it may be advantageous to disconnect an electrical system by opening a circuit breaker in the circuit. Such circumstances can include applications for maintenance and control. It may also be used in applications to prevent use of electrical equipment under a specified or selected voltage. One device used for tripping a circuit breaker because low voltage is detected is an undervoltage release accessory. The undervoltage release accessories currently used have several disadvantages. Some such undervoltage release accessories must be installed in the circuit breaker housing behind the main cover and in close proximity to electrically live parts and connections. Further examples of present undervoltage release accessories are designed to be used with a single circuit breaker frame, i.e., for each current rating of the circuit breaker a specially designed undervoltage release accessory is required.

Thus, there is a need for an undervoltage release accessory to open a circuit breaker that is accurate over a temperature range of −40° C to +120° C. There is an additional need for an undervoltage relay controller that is not dependent upon the temperature of an associated solenoid. There is a further need for an undervoltage release device that can be used with several circuit breaker frame sizes, that is a single undervoltage release device that will operate over a wide range of current ratings for the circuit breaker.

### SUMMARY OF THE INVENTION

There is provided a method for providing undervoltage relay control in a circuit breaker. The method comprises the steps of providing an undervoltage relay apparatus, including a mechanical latch assembly having a mechanical latch mechanism and a solenoid coupled to the circuit breaker. The solenoid is in selective contact with the mechanical latch assembly. Providing an electrical circuit connected to the undervoltage relay apparatus and defining a pre-defined voltage. Receiving a control voltage from a host. Conditioning the control voltage in the electric circuit independently of parameters of the solenoid, wherein if the received voltage is less than the pre-defined voltage, the electrical circuit will remove power to the solenoid, allowing the solenoid to contact the mechanical latch mechanism and trip the circuit breaker. An additional embodiment includes the step of providing a second control voltage greater than the predefined voltage, applying power to the solenoid and resetting the circuit breaker.

There is also provided an undervoltage relay control apparatus monitoring voltage of the circuit breaker. The undervoltage relay controller apparatus comprises a housing with a latch assembly mounted in the housing. The latch assembly includes a latch mechanism and a solenoid, with the solenoid in selective contact with the latch mechanism. An electrical circuit, having a voltage input and a voltage output is mounted in the housing and coupled to the latch assembly. Wherein a control voltage input to the electrical circuit is conditioned, independently of parameters of the solenoid, and wherein if the received control voltage input is less than a predefined voltage, the electrical circuit will remove power to the solenoid allowing the solenoid to contact the latch mechanism and trip the circuit breaker.

There is further provided an undervoltage relay controller apparatus monitoring voltage of a circuit breaker having a trip assembly. The undervoltage relay controller apparatus comprises a housing with a means for contacting the trip assembly mounted in the housing. A means for monitoring the voltage of the circuit breaker is coupled to the means for contacting, wherein a control voltage input to the means for monitoring is conditioned, independently of characteristics of the means for contacting, and wherein if the received control voltage input is less than a pre-defined voltage, the means for monitoring will remove power to the means for contacting allowing the means for contacting to contact the trip assembly and trip the circuit breaker.

### BRIEF DESCRIPTION OF THE DRAWINGS

FIG. 1 is a diagram of a circuit breaker having an operating mechanism, stationary and moving contacts, a line terminal, load terminal, a trip assembly and a precision undervoltage relay controller apparatus with an electrical circuit coupled to a latch assembly.

### DETAILED DESCRIPTION OF THE EXEMPLARY EMBODIMENTS

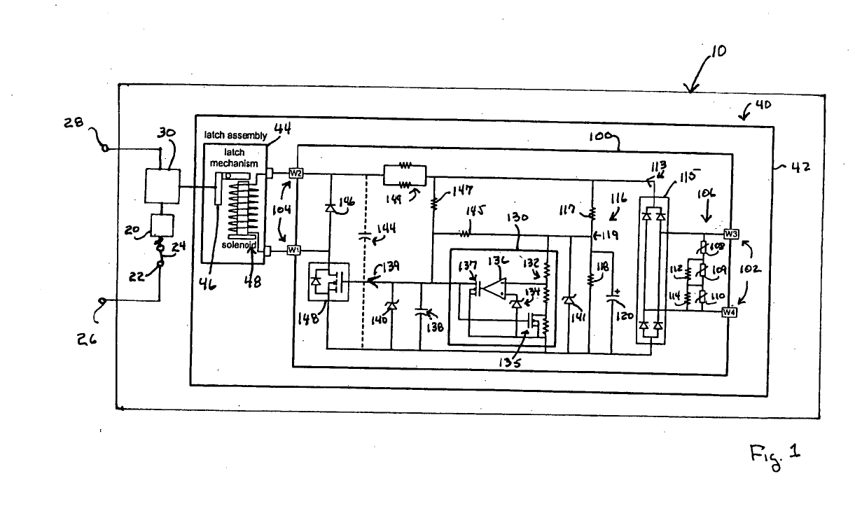

FIG. 1 generally illustrates a circuit breaker 10, which can be a molded case circuit breaker. The circuit breaker 10 is of the type which typically includes an operating mechanism 20 that is coupled to a pivoting member with a handle. The pivoting member and handle are movable between an ON position, OFF position and TRIPPED position. The exemplary circuit breaker 10 can be a three pole breaker having three sets of contacts for interrupting current in each of the three respective electrical transmission phases. In an exemplary embodiment, each phase includes separate breaker contacts and a separate trip mechanism. A center pole circuit breaker includes an operating mechanism which controls the switching of all three poles of the circuit breaker. Although an embodiment of the present invention is described in the context of a single phase circuit breaker, it is contemplated that it may be practiced in a three phase or in other multi-phase circuit breakers.

The handle of the circuit breaker is operable between the ON and OFF positions to enable the contact operating mechanism 20 to engage and disengage a movable contact 24 and a stationary contact 22 for each of the phases such that the line terminal 26 and the load terminal 28 of each phase can be electrically connected and disconnected.

A trip assembly 30 which typically includes a bimetallic element and a magnetic short circuit release is coupled between the line 26 and load 28 terminals of the circuit breaker 10.

An undervoltage relay controller 40 is mounted in the circuit breaker 10 and is selectively connected to the trip assembly 30. The undervoltage relay controller 40 will trip the circuit breaker 10 upon detecting a voltage below a selected value. The undervoltage relay controller 40 upon detecting the low voltage will typically engage a trip bar in the trip assembly 30 causing the release of a mechanism latch of the operating mechanism 20 of the circuit breaker 10. An embodiment of the undervoltage relay controller may have a member protruding through an opening in the circuit breaker's accessory pocket and engage the operating mechanism 20, via a trip bar. An example of an undervoltage release device for a molded case circuit breaker is disclosed in USPN: 6,201,460 assigned to the assignee of the present application.

An exemplary embodiment of a precision undervoltage relay controller 40 (PUVRC) is illustrated in FIG. 1. The relay controller is the control section of an undervoltage relay which includes the relay controller electrical circuit 100, a solenoid 48 and a mechanical latch assembly 44 which includes a latch mechanism 46. The relay controller 40 receives a control voltage 102 from a host. The control voltage 102 can be an alternating voltage (AC) or a direct voltage (DC). The host is typically outside of the circuit breaker 10. If the control voltage 102 is of sufficient amplitude, the relay controller will provide a coiled power for the solenoid 48 in the latch assembly 44. When powered, the solenoid 48 will allow the circuit breaker 10 to be reset. If the control voltage 102 drops below a specified level, it will deenergize the coil of the solenoid 48, causing the circuit breaker 10 to trip. The circuit breaker 10 cannot be reset as long as the control voltage input is below the predetermined operational threshold level.

The relay controller 40 is designed to accommodate an entire voltage rating family for low voltage frame circuit breakers. Operation at a specified rating is derived through the use of component value options on the printed circuit board and the voltage-rated coil assemblies of the solenoid 48. An example of selected components are shown in Table 1 for a 208 VAC undervoltage relay system. The voltage ratings include 12 volts-250 volts in the DC range and 110 volts-600 volts in the AC range.

The control voltage 102 enters the relay controller 40 at terminals W3 and W4 as illustrated in FIG. 1. An electrostatic discharge protection circuit 106 is coupled to the voltage input terminals and includes a selection of varistors 108, 109, 110. Zero-ohm resistors 112, 114 are used to select the varistors. Zero-ohm resistors 112 and 114 can also be referred to as jumpers. In a preferred embodiment, the varistors are rated at 275 volts rms.

The control voltage 102 is further full-wave rectified by diode bridge 115. The full-wave rectified voltage 113 is divided by voltage divider 116 which includes resistors 117 and 118 and a filtering capacitor 120. The DC level voltage is now applied to the input of the voltage detector 130.

The voltage detector 130 is an integrated circuit, for example NCP 301-4.5 volts, that consists of an internal voltage divider 132, a current source, a precision reference 134, a hysteresis switch 135, a comparator 136 and an output driver circuit of a metal on substrate field effect (MOSFET) type transistor 137. The voltage detector 130 does not require a separate power source, but uses a few microamps from the electrical circuit that it is monitoring.

If the divided voltage level 119 is greater than the pre-defined voltage, for example, 4.5 volts DC, then the detector output driver 137 shuts off, causing a high level voltage at 139. This high level is applied across the gate-source of circuit 148 which also is a metal-on-substrate field-effect transistor (MOSFET) and will turn the transistor ON. This transistor 148 provides the coil current return path at W1 as a voltage output 104 from the electrical circuit 100 to the latch assembly 44. Resistors 142 and 143 form a series dropping network which adapts the specific coil of the solenoid 48 to the incoming control voltage. As an example, this allows the use of a 220 volt rated coil with a 480 volt input control voltage.

Capacitor 138 adds further volt capacitance to enhance the gate voltage signal through transistor 148. Zener diodes 140 and 141 provide over-voltage protection for the transistor 148 and voltage detector 130. Resistor 145 provides several volts of switching hysteresis and resistor 147 provides the sourcing voltage to turn the gate of transistor 148 on.

The voltage detector 130, itself, has an internal hysteresis circuit 135. This hysteresis circuit 135 introduces approximately 0.250 volts hysteresis at the input 119 to the voltage detector 130. An optional capacitor 144 can be added if additional power is required to actuate the solenoid 48 coil. The rectifier 146 serves as a coil fly-back diode.

The relay controller 40, as mentioned above, will accommodate an entire range of control voltage input levels. By selecting the proper values for the various elements in the electrical circuit 100 the full range of voltage ratings can be accommodated. Resistors 117 and 118 form the input voltage divider 116. These resistor values are selected to cause voltage detection state change at approximately 50% of the input voltage range. For example, the detector will change state at an input of 61.0 volts for the 110 volt- 112 volt range. Below is a table, Table 1, which provides values for an exemplary embodiment of a precision undervoltage relay system for a 208 volt AC undervoltage relay controller of a circuit breaker.

TABLE 1
Exemplary Embodiment of 208 VAC
Precision Undervoltage Relay Circuit

| Element | | |
|---|---|---|
| Number | | |
| 48 | = | Coil resistance @ 23° C. = 11 k |
| | | ohms |
| 108 | = | 275 VRMS Varistor |
| 109 | = | 275 VRMS Varistor |
| 110 | = | NONE |
| 112 | = | None |
| 114 | = | Z ohms |
| 115 | = | DF08-800 v. |
| 117 | = | 470 k ohms |
| 118 | = | 23.2 k ohms |
| 120 | = | 1 uF |
| 130 | = | NCP303-4.5 v |
| 138 | = | 0.1 uF |
| 140 | = | Zener Diode - 10 v |
| 141 | = | Zener Diode - 7.5 v |
| 144 | = | None |
| 145 | = | 1 meg ohm |
| 146 | = | GF1K |
| 147 | = | 470 k ohm |
| 148 | = | STD2NB80T4 |
| 149 | = | 2-18 k ohms in parallel |

208 vac UVR control PCB
Precision Undervoltage Relay System

| | specified control | actual control |
|---|---|---|
| | voltage | voltage |
| UVR dropout | must dropout between | 102 vac |
| | 146 vac and 73 vac | |
| UVR reset | must reset at or | 112 vac |
| | below 177 vac | |

The bulk capacitor 120 is selected to provide adequate filtering of the voltage being monitored by the voltage divider. This capacitance must be kept to a minimum to allow fast initialization times at turn on. This fast turn on is necessary to comply with rotational actuator requirements.

When the circuit breaker 10 is engaged, for example reset, the relay controller 40 quickly detects the magnitude qualification of the input control voltage 102. If the voltage at 119 falls below the pre-determined voltage, for example, 4.5 volts, then the detector output driver 137 turns on, issuing a low gate level, turning the main driver 148 and coil of the solenoid 48 OFF. This will cause the circuit breaker 10 to drop out, or trip.

Conversely, if the control voltage level 102 causes the input 119 to be above the pre-determined voltage, for example, 4.5 volts, then the detector output driver 137 will shut off, allowing the gate of main driver transistor 148 to be enabled, receiving gate charge through resistor 147. The main driver transistor 148 turns on to allow power to the coil of solenoid 48 which will allow the circuit breaker 10 to be reset.

As a result of the precision of the integrated voltage detector 130, the relay controller 40 is inherently more accurate over the entire temperature range, −40° C to +120° C. The tolerance analysis results give a 3 Sigma probability of accuracy within 2.4%. This exceeds the accuracy of relay designs based on Zener diode references and solenoid coil characteristics, for example operating temperature, which can result in cumulative total errors of between 7% and 12%.

While the embodiments illustrated in the figure and described above are presently preferred, it should be understood that these embodiments are offered by way of example only. The invention is not intended to be limited to any particular embodiment, but it is intended to extend to various modifications that nevertheless fall within the scope of the intended claims. For example, it is contemplated that the trip mechanism having a bi-metal trip unit or an electronic trip unit with a load terminal can be housed in a separate housing capable of mechanically and electrically connecting to another separate housing containing the operating mechanism and line terminal of the circuit breaker. Other modifications will be evident to those with ordinary skill in the art.

What is claimed is:

1. A method for providing undervoltage relay control in a circuit breaker, the method comprising the steps of:
providing an undervoltage relay apparatus, including a mechanical latch assembly having a mechanical latch mechanism and a solenoid, coupled to the circuit breaker, with the solenoid in selective contact with the mechanical latch assembly;
providing an electrical circuit connected to the undervoltage relay apparatus and providing a pre-defined voltage;
receiving a control voltage from a host;
conditioning the control voltage in the electric circuit independently of characteristics of the solenoid, wherein if the received voltage is less than the pre-defined voltage the electrical circuit will remove power to the solenoid allowing the solenoid to contact the mechanical latch mechanism and trip the circuit breaker.

2. The method of claim 1, including the step of varying the pre-defined voltage.

3. The method of claim 2, wherein the pre-defined voltage is set at 4.5 volts.

4. The method of claim 1, including the steps of:
providing a second control voltage greater than the pre-defined voltage;
applying power to the solenoid; and
resetting the circuit breaker.

5. The method of claim 4, including the step of detecting a magnitude qualification of the control voltage.

6. The method of claim 5, wherein detecting includes engaging a detector output driver wherein if the control voltage falls below 4.5 volts, the detector issuing a low gate level and deactivating a main driver MOSFET and the solenoid to trip the circuit breaker.

7. The method of claim 5, wherein the detecting includes the steps of:
disengaging the detector output driver if the control voltage is above 4.5 volts;
enabling a gate of the main driver MOSFET;
receiving a gate charge through a resistor; and
providing power to the solenoid to allow the circuit breaker to be reset.

8. The method of claim 1, including the step of preventing the circuit breaker from resetting as long as the control voltage is below the pre-defined voltage.

9. The method of claim 1, wherein the method can be performed in a temperature range from at least −40C to +120C.

10. The method of claim 1, wherein the step of receiving includes providing electrostatic discharge protection.

11. The method of claim 1, wherein the control voltage is one of alternating type voltage and direct type voltage.

12. An undervoltage relay controller apparatus monitoring voltage of a circuit breaker, the undervoltage relay controller apparatus comprising:
a housing;
a latch assembly mounted in the housing and having a latch mechanism and a solenoid, with the solenoid in selective contact with the latch mechanism; and
an electrical circuit, having a voltage input and voltage output, mounted in the housing and coupled to the latch assembly,
wherein a control voltage input to the electrical circuit is conditioned, independently of characteristics of the solenoid, and wherein if the received control voltage input is less than a pre-defined voltage , the electrical circuit will remove power to the solenoid allowing the solenoid to contact the latch mechanism and trip the circuit breaker.

13. The undervoltage relay controller apparatus of claim 12, wherein the pre-defined voltage is set at 4.5 volts.

14. The undervoltage relay controller apparatus of claim 12, wherein the electrical circuit includes an electrostatic discharge protection circuit coupled to the control voltage input.

15. The undervoltage relay controller apparatus of claim 12, wherein the control voltage is one of alternating type voltage and direct type voltage.

16. The undervoltage relay controller apparatus of claim 12, wherein the electrical circuit includes a voltage detector, coupled to the voltage input and voltage output, the detector having an internal voltage divider, a current source, a precision voltage reference, a hysteresis switch , a comparator and an output driver.

17. The undervoltage relay controller apparatus of claim 12, wherein a second control voltage is conditioned by the electrical circuit, and wherein if the received second control voltage input greater than the pre-defined voltage, the electrical circuit will apply power to the solenoid allowing the solenoid to disengage from the latch mechanism and reset the circuit breaker.

18. The undervoltage relay controller apparatus of claim 12, wherein the apparatus can operate in a temperature range of at least −40C to +120C.

19. An undervoltage relay controller apparatus monitoring voltage of a circuit breaker having a trip assembly, the undervoltage relay controller apparatus comprising:
a housing;
a means for contacting the trip assembly mounted in the housing; and
a means for monitoring the voltage of the circuit breaker and coupled to the means for contacting,
wherein a control voltage input to the means for monitoring is conditioned, independently of characteristics of the means for contacting, and wherein if the received control voltage input is less than a pre-defined voltage, the means for monitoring will remove power to the means for contacting allowing the means for contacting to contact the trip assembly and trip the circuit breaker.

20. The undervoltage relay controller apparatus of claim 19, wherein the pre-defined voltage is set at 4.5 volts.

21. The undervoltage relay controller apparatus of claim 19, wherein the control voltage is one of alternating type voltage and direct type voltage.

22. The undervoltage relay controller apparatus of claim 19, wherein a second control voltage is conditioned by the means for monitoring, and wherein if the received second control voltage input greater than the pre-defined voltage, the means for monitoring will apply power to the means for contacting allowing the means for contacting to disengage from the trip assembly and reset the circuit breaker.

23. The undervoltage relay controller apparatus of claim 19, wherein the apparatus can operate in a temperature range of at least −40C to +120C.
